(19) United States
(12) Patent Application Publication
(10) Pub. No.: US 2007/0033424 A1
(43) Pub. Date: Feb. 8, 2007

(54) Power management device with a remote control function

(76) Inventor: Steve Cheng, Kuei Shan Hsiang (TW)

Correspondence Address: RABIN & BERDO, P.C., Suite 500, 1101 14 Street, N.W., Washington, DC, 20005, US

(21) Appl. No.: 11/257,085

(22) Filed: Oct. 25, 2005

(30) Foreign Application Priority Data
Aug. 8, 2005 (TW) 094213506

(51) Int. Cl. G06F 1/26

(52) U.S. Cl. 713/300

(57) ABSTRACT

A power management device with a remote control function configured in a computer system includes a power management unit, a remote control receiver, and a remote control transmitter. The power management unit is configured in the computer system for managing the power of the computer system. The remote control receiver is electrically connected to the power management unit. The remote control transmitter is used for transmitting a control signal. The control signal is received and processed by the remote control receiver to control the power management unit.

### RELATED APPLICATIONS

The present application is based on, and claims priority from, Taiwan Application Ser. No. 94213506, filed Aug. 8, 2005, the disclosure of which is hereby incorporated by reference herein in its entirety.

### BACKGROUND

1. Field of Invention

The present invention relates to a power management device with a remote control function. More particularly, the present invention relates to a power management device with a remote control function, configured in a computer system.

2. Description of Related Art

As the lives of modern people get busier, more and more automatic household appliances are being provided by many manufactures. Many household appliances are able to communicate with a computer system, enabling all household appliances to be integrated by the computer system.

A personal computer can be a home server today. Besides the original functions, for example, internet access, office applications, editing and storing digital data, paying digital video discs (DVD) or compact discs (CD) and so on, the home server should be able to manage all household appliances by a wireless local area network (LAN).

However, the power switch of a computer system, whether it is a desktop computer or a notebook computer, is usually a power button. The user of the computer system needs to push the power button to turn on the computer system.

The home server is supposed to be concealed in a discrete location. Thus, pressing the power button is inconvenient for the user if the home server uses a power button as the power switch.

Moreover, a traditional remote control receiver, configured in a computer system, is powered off when the computer system is powered off. Therefore, the traditional remote control receiver cannot receive a control command by a user. In other words, the traditional control receiver cannot boot the computer system.

For the foregoing reasons, there is a need for controlling the power of the computer system when the computer system is hidden.

### SUMMARY

It is therefore an aspect of the present invention to provide a power management device with a remote control function, configured in a computer system, to make operating the computer system easier for the user.

It is another aspect of the present invention to provide a power management device with a remote control function, configured in a computer system, such that the user of the computer system can remotely turn on and turn off the computer system.

In accordance with the foregoing and other objectives of the present invention, a power management device with a remote control function is provided. The power management device can be configured in a computer system and includes a power management unit, a remote control receiver, and a remote control transmitter. The power management unit is configured in the computer system for managing the power of the computer system. The remote control receiver is electrically connected to the power management unit. The remote control transmitter is used for transmitting a control signal. The control signal is received and processed by the remote control receiver to control the power management unit.

In one preferred embodiment of the present invention, the remote control receiver is in a standby state when the computer system is off for receiving the control signal. The control signal includes a power-on signal for turning on the computer system.

The power management device with the remote control function can be configured in any type of the computer system, especially in a home server. The user of the computer system can transmit the control signal by the remote control transmitter for controlling the power of the computer system. In other words, the user of the computer system can remotely turn on and turn off the computer system.

It is to be understood that both the foregoing general description and the following detailed description are by examples and are intended to provide further explanation of the invention as claimed.

### BRIEF DESCRIPTION OF THE DRAWINGS

The accompanying drawing is included to provide a further understanding of the invention and is incorporated in and constitutes a part of this specification. The drawing illustrates embodiments of the invention and, together with the description, serves to explain the principles of the invention. In the drawing,

FIG. 1 is a block diagram of a power management device with a remote control function according to one preferred embodiment of this invention.

### DESCRIPTION OF THE PREFERRED EMBODIMENTS

Reference will now be made in detail to the present preferred embodiments of the invention, examples of which are illustrated in the accompanying drawing. Wherever possible, the same reference numbers are used in the drawings and the description to refer to the same or like parts.

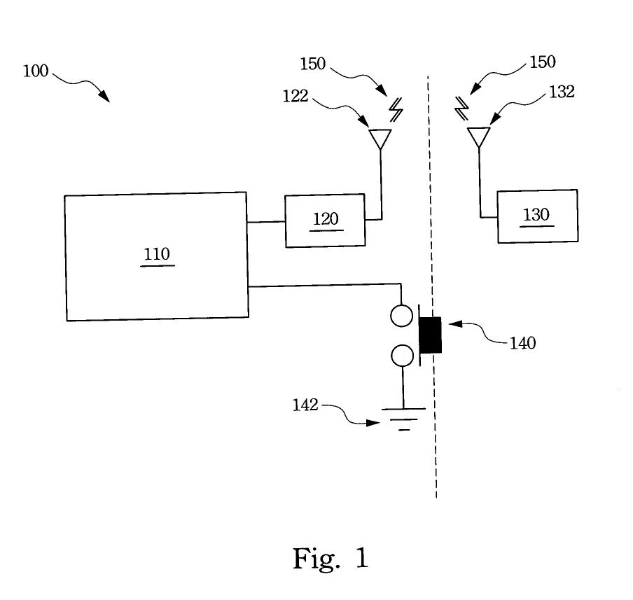

Reference is made to FIG. 1, which is a block diagram of a power management device with a remote control function according to one preferred embodiment of this invention. The power management device 100 includes a power management unit 110, a remote control receiver 120, and a remote control transmitter 130. The power management unit 110 is configured in a computer system for managing the power of the computer system. The remote control receiver 120 is electrically connected to the power management unit 110. The remote control transmitter 130 is used for transmitting a control signal 150. The control signal 150 is received and processed by the remote control receiver 120 to control the power management unit 110.

A wired controller 140 is configured in the computer system. The wired controller 140 is electrically connected to the power management unit 110 for controlling the power management unit 110. In one preferred embodiment, the wired controller 140 includes a power button. Moreover, the wired controller 140 may further include a grounding conductor electrically connected to the wired controller.

The control signal 150 includes a power-on signal for turning on the computer system. Furthermore, the control signal 150 may also include a power-off signal for turning off the computer system.

The remote control receiver 120 is in a standby state when the computer system is off such that it can receive the control signal 150. Thus, the user of the computer system can remotely control the power of the computer system, for example, turning on the computer system, even if the computer system is off.

The remote control receiver 120 may turn off the computer system by an operating system. Alternatively, the remote control receiver 120 may also directly turn off the computer system.

The remote control receiver 120 has a receiving antenna 122 for receiving the control signal 150. Similarly, the remote control transmitter 130 has a transmitting antenna 132 for transmitting the control signal 150.

In one preferred embodiment of the present invention, the remote control transmitter 130 has a Bluetooth transmitting module and the remote control receiver 120 has a Bluetooth receiving module. In another preferred embodiment of the present invention, the remote control transmitter 130 has an infrared light transmitting module and the remote control receiver 120 has an infrared light receiving module.

In still another preferred embodiment of the present invention, the remote control transmitter 130 has a radio frequency transmitting module and the remote control receiver 120 has a radio frequency receiving module. A communication system between the radio frequency transmitting module and the radio frequency receiving module is Wi-Fi, Zigbee or Ultra wideband.

In conclusion, the invention has advantages as follows:

(1) The user of the computer system can remotely control the power of the computer system because the power management device configured in the computer system has the remote control receiver and the remote control transmitter.

(2) Because the remote control receiver is in a standby state when the computer system is off, the user of the computer system can remotely turn on the computer system even if the computer system is off.

(3) Because the remote control receiver may directly turn off the computer system without any operating system assistance, the present invention can be compatible with any operating systems.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power management device configured in a computer system, the power management device comprising:
a power management unit configured in the computer system for managing the power of the computer system;
a remote control receiver electrically connected to the power management unit; and
a remote control transmitter for transmitting a control signal, wherein the control signal is received and processed by the remote control receiver for controlling the power management unit.

2. The power management device of claim 1, further comprising:
a wired controller electrically connected to the power management unit for controlling the power management unit.

3. The power management device of claim 1, wherein the control signal comprises a power-on signal for turning on the computer system.

4. The power management device of claim 1, wherein the control signal comprises a power-off signal for turning off the computer system.

5. The power management device of claim 1, wherein the remote control receiver has a receiving antenna for receiving the control signal.

6. The power management device of claim 1, wherein the remote control transmitter has a transmitting antenna for transmitting the control signal.

7. The power management device of claim 1, wherein the remote control transmitter has a Bluetooth transmitting module and the remote control receiver has a Bluetooth receiving module.

8. The power management device of claim 1, wherein the remote control transmitter has an infrared light transmitting module and the remote control receiver has an infrared light receiving module.

9. The power management device of claim 1, wherein the remote control transmitter has a radio frequency transmitting module and the remote control receiver has a radio frequency receiving module.

10. The power management device of claim 9, wherein a communication system between the radio frequency transmitting module and the radio frequency receiving module is selected from a group consisting of Wi-Fi, Zigbee and Ultra wideband.

11. The power management device of claim 1, wherein the remote control receiver is in a standby state, when the computer system is off, for receiving the control signal.

12. A power management device configured in a computer system, the power management device comprising:
a power management unit configured in the computer system for managing the power of the computer system;
a remote control receiver electrically connected to the power management unit; and
a remote control transmitter for transmitting a power-on signal wherein the power-on signal is received and processed by the remote control receiver for controlling the power management unit.

13. The power management device of claim 12, further comprising:
a wired controller electrically connected to the power management unit for controlling the power management unit.

14. The power management device of claim 12, wherein the remote control receiver has a receiving antenna for receiving the power-on signal.

15. The power management device of claim 12, wherein the remote control transmitter has a transmitting antenna for transmitting the power-on signal.

16. The power management device of claim 12, wherein the remote control transmitter has a Bluetooth transmitting module and the remote control receiver has a Bluetooth receiving module.

17. The power management device of claim 12, wherein the remote control transmitter has an infrared light transmitting module and the remote control receiver has an infrared light receiving module.

18. The power management device of claim 12, wherein the remote control transmitter has a radio frequency transmitting module and the remote control receiver has a radio frequency receiving module.

19. The power management device of claim 18, wherein a communication system between the radio frequency transmitting module and the radio frequency receiving module is selected from a group consisting of Wi-Fi, Zigbee and Ultra wideband.

20. The power management device of claim 1, wherein the remote control receiver is in a standby state, when the computer system is off, for receiving the power-on signal.
